(19) United States
(12) Patent Application Publication
(10) Pub. No.: US 2004/0088192 A1
(43) Pub. Date: May 6, 2004

(54) Medical office electronic management system

(76) Inventors: Tim W. Schmidt, Rochester, NY (US); Joseph A. DiPoala JR., Rochester, NY (US)

Correspondence Address: BROWN & MICHAELS, PC, 400 M & T BANK BUILDING, 118 NORTH TIOGA ST, ITHACA, NY, 14850, US

(21) Appl. No.: 10/287,181

(22) Filed: Nov. 4, 2002

(51) Int. Cl. G06F 17/60

(52) U.S. Cl. 705/3

(57) ABSTRACT

An electronic medical records and medical office management system includes electronic storage, retrieval, analysis, and transmittal of patient records, and is integrated with office scheduling and billing. One embodiment of the record-keeping and office management system further includes an electronic encounter feature that integrates with billing, generates referrals, orders labs and tests, allows for medications to be prescribed, and directs for a follow-up visit, as needed; automatic electronic notification; integrated appointment scheduling; preventive care profile integration with the electronic encounter; history and exam findings entry, wherein data convert to text; note creation, which draws from a patient record, encounter data and events triggered, and patient history and exam findings; and electronic document management, including incoming mail.

### BACKGROUND OF THE INVENTION

1. Field of the Invention

The invention pertains to the field of medical office management. More particularly, the invention pertains to a comprehensive electronic medical records and integrated medical office management system.

2. Description of Related Art

Medical record-keeping, including storage, retrieval, analysis, and transmittal of patient records, as well as office management, including scheduling and billing, both are vital aspects of medical office management. Typically, however, these functions are performed by separate systems that are not integrated together. For example, in regard to general workflow, usually, when a patient checks in, a nurse or assistant periodically checks a sign-in sheet or with the front desk to know that a patient has arrived. After placing the patient in a room and recording vitals in the patient's chart, the nurse or assistant typically uses colored flags outside the door to indicate that a patient is there, and the doctor periodically checks the colored flags to know that a patient is waiting. If the doctor needs nurse intervention for a test, injection, handout, etc., the doctor walks to the nurse's area and communicates verbally. The nurse or assistant then does what was requested, and then finds the doctor to communicate that the requested task is completed. The doctor may or may not return to the patient. The doctor then writes down on paper instructions for the front desk, upon the patient's check-out.

In regard to the doctor's workflow, typically the doctor takes notes and either dictates the entire note (for transcription) or hand-writes it. If the practice has electronic medical records, a good system will have a chart creator, and data are entered that produces text. The text generated, however, is totally independent of such information as medications prescribed, labs ordered, handouts given, etc. That is to say, the doctor has to do one function to initiate an action (printing a prescription, for example), and then has to take another action in the chart creator to document that a prescription was given (for example). Therefore, ordering something and putting that item in the note are two separate functions.

Thus, there is a need in the art for a comprehensive electronic medical records and medical office management system that provides for electronic storage, retrieval, analysis, and transmittal of patient records, and which is tightly integrated with office scheduling and billing. Such a system would have the advantage of, among other things, complete integration, thereby reducing the number of tasks required by medical office personnel, thereby increasing efficiency.

### SUMMARY OF THE INVENTION

Briefly stated, the present invention provides an electronic medical records and medical office management system, including electronic storage, retrieval, analysis, and transmittal of patient records, and which is integrated with office scheduling and billing. In one embodiment, the record-keeping and office management system further includes an electronic encounter feature that integrates with billing, generates referrals, orders labs and tests, allows for medications to be prescribed, and directs for a follow-up visit, as needed; automatic electronic notification; integrated appointment scheduling; preventive care profile integration with the electronic encounter; history and exam findings entry, wherein data convert to text; note creation, which draws from a patient record, encounter data and events triggered, patient history and exam findings; and electronic document management, including incoming mail.

### DETAILED DESCRIPTION OF THE INVENTION

The present invention provides a comprehensive electronic medical records and medical office management system that provides for electronic storage, retrieval, analysis, and transmittal of patient records, and which is tightly integrated with office scheduling and billing. The system is of particular utility to doctors, insurance companies, health care systems and individual practice organizations.

In the preferred embodiment, the system includes the following features:

1) Electronic encounter (that integrates with billing, generates referrals, orders labs and tests, allows for medications to be prescribed, directs for a follow-up visit);

2) Automatic electronic notification;

3) Integrated appointment schedule;

4) Preventive care profile integration with electronic encounter;

5) History and exam findings entry (data that will convert to text);

6) Note creation which draws from the patient record, the encounter data and events triggered, and the history and exam findings;

7) Electronic document management (incoming mail).

The present system differs from prior methods in that, among other features, it includes full integration of record-keeping and office management functions. For example, an action taken in one window is automatically carried over to another, and the electronic encounter is linked to preventive care information and the chart creator, as described in further detail below.

Beyond what has become relatively standard in electronic medical record-keeping, the present system creates a new paradigm in the “patient workflow” and medical documentation.

“Patient workflow” describes the process by which a patient moves through the medical office during his visit to the medical provider. It begins with patient check-in, is followed by the patient's visit with the nurse or other assistant, then the patient's time with the doctor, subsequent intervention by the nurse and/or doctor, patient check out, and finally the completion of the medical record.

A new paradigm is created through the use of:

Electronic Notification—Automatically generated point to point computerized notification of the patient's status (notifying the appropriate person when the patient has arrived, where the patient is, what is needed, etc.).

Integrated Appointment Schedule—A mini-version of the doctor's schedule appears within the medical record portion of the program and can be used to move from patient to patient. This schedule is enhanced through special color-coding that indicates the stage of the patient's visit, where he is, and for which member of the office team the patient is waiting.

Guided Completion of Patient Care—The doctor is prompted, through the use of color-coded flags based on the patient's disease management and care profile, to order preventive care procedures based on the patient's medical history. This greatly improves office efficiency and the quality of patient care.

Electronic Encounter Form—The electronic encounter provides a superior alternative to its traditional paper counterpart. A multiple-tabbed window, it contains one or more separate pages on which the provider can select procedures, diagnoses, lab tests, radiology studies, referrals to specialists, and medications. It brings together in one window all of the commonly performed actions that make up the patient encounter. Unique to our electronic encounter is the inclusion of diagnoses from the patient's medical history. Every diagnosis, order or referral selected on the encounter is automatically included in the progress note generated for that day's visit.

In addition, many of these elements trigger other actions when selected. For example, electronic notification of the nurse occurs when items selected require her intervention; prescriptions, referrals, tests and radiology requisitions are printed; a claim is created for insurance/patient billing; the front desk is prompted at patient check out to schedule a return visit (or visits) based on the doctor's selection here; the patient's preventive care or disease management profile is updated; the patient's other physicians receive an automatically generated letter outlining the patient's status at the time of the visit and any changes made to the patient's medical regimen; introductory letters to new consultants are automatically generated using data already entered into the EMR.

Entry of Problem History and Exam Findings—There is a series of buttons that allows for entry of the history of the illness, as well as exam findings. Each button relates to a different body system, and opens up a data entry form. Most of these forms have multiple levels of sub-forms that appear for documentation of greater degrees of specificity. These windows contain fields of data, e.g., checkboxes, radio buttons, drop-down selection boxes, etc., depending on the type of data being collected. The values of these fields can be entered individually by the doctor, but are for the most part preset, depending on the patient's profile and the type of visit for which the patient presents.

The exam profile(s) selected is determined by one or more of three factors: the patient's past medical history, his disease profile, or his acute symptomatology. Additionally, exam findings can be carried over from the patient's previous visit(s). Typically, in the prior art, entering exam findings would normally require dozens of keystrokes and mouse clicks. Through the use of profiling, this is dramatically reduced. With just a few clicks, a very complex history and examination can be recorded. This is due to the system's ability to build a case history database. It is an ever-increasing database that becomes progressively more complete as it is used. Based on the above information, the system draws from this database to provide a “starting point” from which more data, specific to the current patient, can be entered. In many cases, it is complete of itself (requires no further entry).

Note Creation—The progress note is created primarily from three sources: 1) data from the electronic encounter, 2) data drawn from other parts of the patient's record, and 3) the history and exam data entered.

The data from the electronic encounter creates the framework for the note. This provides information about the type of visit, the patient's vitals (typically entered by the nurse), the procedures performed, diagnoses, any medications given (including medications started, stopped, or changed), labs or radiology ordered, referrals made, handouts given, and when the patient should return for follow-up.

Data is drawn from other parts of the patient's record. This includes their family history and social history, medications as well as patient demographic information (e.g., primarily, name, age and sex).

The bulk of the note comes from the history and exam data entered. The checkboxes, radio buttons, etc., used to select specific information regarding the history of the present illness and the doctor's findings, are translated into actual text. The text generation engine offers a very high degree of complex sentence structure, through the use of multiple-layered object groupings. A group is a collection of linked data that translate in a variety of ways, depending on the value of the elements in the group and the group format. The ability to do multiple layers of groups allows for a variety of ways for a master group to be translated, depending on the values of sub-groups. The engine produces a very accurate, detailed and smooth text translation.

The program also automatically documents diagnoses with their associated procedures, orders and changes in the treatment regimen.

Electronic Document Management—Incoming mail (e.g., lab results, radiology tests results, letters from consultants, etc.) are scanned in, viewed and routed electronically. These documents are “filed” in the respective patients' medical record, as well as appear in the appropriate doctor's in-box. Data entry windows appear, which vary depending on the type of document, that allow values contained in the reports to be entered. These values are recorded directly in the patient's preventive care data and “trackables,” and are most often automatically included in the note for the next visit. Electronic notes can be attached to the documents, for example, directing the nurse or other office staff as to how to process the information (e.g., “call patient—negative results”, etc.) In short, it allows for incoming documents to be viewed, notation made and filed electronically.

Electronic Notification—makes for a smooth office workflow. Office traffic is reduced; time is saved by having the regular office communications occur electronically and automatically.

Integrated Appointment Scheduler—Helps doctors and nurses stay on schedule. It provides information on the status of each patient in the office, and for which member of the office team they are waiting. It allows for simple navigation from each medical record with a single click. Uses color-coding and font attributes to indicate when a patient has checked in, when a patient is the nurse's or doctor's responsibility, when the doctor has left the exam room, when the patient has checked out, and when the doctor electronically signs today's note.

Three of the main functions built into our electronic encounter are new to the art:

Items ordered appear in the note, linked to specific diagnoses. Typically, the ordering of items (labs, tests, medications, etc.) and the documenting of the treatment plan are separate things. Here the one produces the other.

Integration with Preventive Care. The preventive care window tracks tests, injections, procedures, referral, etc., that need to be made at regular intervals, depending on the patient's history, disease management, age, sex, etc. Preventive care items that are overdue appear in red on the encounter, to flag the provider that they should be ordered. When the provider clicks on one, the patient's preventive care data are automatically updated. Apart from this invention, the doctor would have to check the preventive care record to ensure the proper items are ordered; the preventive care record would also have to be updated separately.

Items ordered that require intervention of the nurse or other office staff automatically trigger electronic notification. A message is sent to the appropriate staff member immediately. Apart from this invention, these messages would be communicated verbally.

Electronic notification is another feature that is new to the art. Although intra-office messaging is not unique, having it happen automatically (i.e., without user-intervention) to establish a workflow in the medical office, step by step, apparently has never been done before.

Integration of preventive care profiling with the electronic encounter also is unique to our system. When an item is due, the linked procedure, lab, radiology test, or handout appears in red on the encounter. When a preventive care item is ordered on the encounter, it automatically updates the patient's preventive care record.

The automatic inclusion of data from the electronic encounter into the progress note also is unique to our system, as is the way the system brings together the various elements of data to produce a complete note. More particularly, the note preferably introduces the patient by name, age, sex, race, and reason for the visit; details the history of the illness through data entered by the doctor (text generated from data entry forms); incorporates vitals entered by the nurse (blood pressure, weight, height, etc.), details exam findings (text generated from data entry forms); incorporates the patient medication list, with changes noted (new medications ordered, medications stopped, medications updated); lists procedures performed; lists labs or radiology tests ordered; lists referrals to specialists; lists handouts given; lists the doctor's diagnoses; links actions taken (medications prescribed, labs ordered, handouts given, etc.) linking them to individual diagnosis codes (for example, this was done because of this problem, this was done for this problem, etc.); includes when the doctor wants to see the patient for a follow-up visit, and allows for dictation flags inserted at any point in the note, that provide a link to voice recognition software.

Unique to the present system is the fact that, during the operation of the present system, electronic notification has triggers in important elements of the workflow. These include:

The Appointment Scheduler nurse is notified when patient checks in.

The Vitals window—after nurse enters vitals, doctor is notified patient is waiting, for what and in what room.

The Electronic Encounter—when the doctor orders procedures, handouts, etc., that require nurse intervention, nurse is notified. This can be done when the doctor completes the visit, or in the middle of the visit, if desired.

Charge Entry—when the patient checks out, the front desk staff is notified of special instructions from the doctor, including referrals to other doctors and return visits to be scheduled.

Further, the present system includes the following features, which are entirely new to the art:

General workflow—the general flow of the patient is tracked from check in to check out in the office. Also, the electronic notification (with its various trigger points) and an integrated appointment schedule allow unique display attributes (colors and fonts). The presence of these initiate and indicate the flow of the patient through the office.

Doctor's workflow—the ordering of procedures, tests, handouts, etc. can be performed from the electronic encounter. Beyond entry of the order itself, each with a corresponding result (printing of a script, requisition, etc.) the order links directly to the note and the patient's preventive care record. Electronic notification is also triggered to other staff as appropriate. The electronic encounter itself contains color-coded prompts for the physician guiding him towards recommended preventive care items and alerting him regarding pertinent elements of the patient's history. The tightly woven integration of ordering with these other functions is unique.

Another unique feature of the system is that the entry of data into the system produces a fully-integrated note. The note creator pulls data from the history of present illness data and exam data (both of which produce text from data), actions ordered (labs, handouts, etc.), procedures done, referrals made, existing elements of the patient's medical record (family & social history, medication list), vitals, etc. Items ordered are also linked to specific diagnoses for an automatic formulation of the treatment plan. Its synthesis of these elements is unique. Also unique is the linking of preventive care data to procedures, labs, handouts, or radiology requisitions. As these items are ordered, preventive care data is automatically updated.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An electronic medical records and medical office management system, comprising:
means for electronic storage, retrieval, analysis, and transmittal of patient records, and which is integrated with office scheduling and billing.

2. The record-keeping and office management system of claim 1, further comprising:
a) an electronic encounter feature that integrates with billing, generates referrals, orders labs and tests, allows for medications to be prescribed, and directs for a follow-up visit, as needed;
b) automatic electronic notification;
c) integrated appointment scheduling;
d) preventive care profile integration with said electronic encounter;
e) history and exam findings entry, wherein data convert to text;
f) note creation, which draws from a patient record, encounter data and events triggered, and patient history and exam findings;
g) electronic document management, including incoming mail.

3. The record-keeping and office management system of claim 1, wherein the general flow of the patient is tracked from check in to check out in the office.

4. The record-keeping and office management system of claim 3, wherein general workflow is tracked using electronic notification, and including an integrated appointment schedule with unique display attributes.

5. The record-keeping and office management system of claim 4, wherein unique display attributes include unique colors and/or fonts.

6. The record-keeping and office management system of claim 1, wherein the doctor's workflow is tracked by the system.

7. The record-keeping and office management system of claim 6, wherein the doctor's workflow includes ordering of procedures, tests or handouts from an electronic encounter.

8. The record-keeping and office management system of claim 7, wherein the order links directly to the note and the patient's preventive care record.

9. The record-keeping and office management system of claim 7, wherein the Electronic notification is triggered to other staff, as appropriate.

10. The record-keeping and office management system of claim 7, wherein the electronic encounter contains color-coded prompts for the physician, guiding him towards recommended preventive care items and alerting him regarding pertinent elements of the patient's history.

11. The record-keeping and office management system of claim 1, further comprising the entry of data to produce a fully-integrated note.

12. The record-keeping and office management system of claim 1, wherein a note creator pulls data from the history of present illness data and exam data, both of which produce text from data, actions ordered, procedures done, referrals made, existing elements of the patient's medical record (family & social history, medication list), or vitals.

13. The record-keeping and office management system of claim 12, wherein items ordered are also linked to specific diagnoses for an automatic formulation of the treatment plan.

14. The record-keeping and office management system of claim 1, further comprising the linking of preventive care data to procedures, labs, handouts, or radiology requisitions, and, as these items are ordered, preventive care data is automatically updated.

15. The record-keeping and office management system of claim 1, the exam profile(s) selected is determined by one or more factors, including the patient's past medical history, his disease profile, or his acute symptomatology.

16. The record-keeping and office management system of claim 1, the checkboxes, radio buttons, etc. used to select specific information regarding the history of the present illness and the doctor's findings are translated into actual text.

17. The record-keeping and office management system of claim 1, items ordered appear in the note, linked to specific diagnoses.

18. The record-keeping and office management system of claim 1, comprising integration with preventive care.

19. The record-keeping and office management system of claim 1, items ordered that require intervention of a nurse or other office staff automatically trigger electronic notification.
